(19) United States
(12) Patent Application Publication
(10) Pub. No.: US 2021/0394616 A1
(43) Pub. Date: Dec. 23, 2021

(54) Method and Apparatus for Real-Time Acceleration Indication

(71) Applicant: Bruce Matthew Paggeot, Leander, TX (US)

(72) Inventor: Bruce Matthew Paggeot, Leander, TX (US)

(21) Appl. No.: 17/356,445

(22) Filed: Jun. 23, 2021

Related U.S. Application Data
(60) Provisional application No. 63/042,972, filed on Jun. 23, 2020.

(51) Int. Cl. B60K 35/00

(52) U.S. Cl. CPC B60K 35/00; B60K 2370/332; B60K 2370/152; B60K 2370/167

(57) ABSTRACT

An acceleration system hardware for calculating and displaying acceleration information relevant to the movement of vehicle. The acceleration system hardware comprises a plurality of computation components and a display system. The plurality of computation components comprises a sensor package, a memory and a processing unit. The sensor package comprises at least an accelerometer. The memory comprises a system application which is in communication with the plurality of computation components and executed in the processing unit. The display system is configured for converting processed accelerometer data into a visual indication of the magnitude of the acceleration. The acceleration system hardware is configured for capturing acceleration data, processing into the processed accelerometer data, ingesting with the processing unit according to the system application.

### CROSS-REFERENCE TO RELATED APPLICATIONS

This application claims benefit to U.S. Patent Application No. 63/042,972 filed on 2020 Jun. 23.

### STATEMENT REGARDING FEDERALLY SPONSORED RESEARCH OR DEVELOPMENT (IF APPLICABLE)

Not applicable.

### REFERENCE TO SEQUENCE LISTING, A TABLE, OR A COMPUTER PROGRAM LISTING COMPACT DISC APPENDIX (IF APPLICABLE)

Not applicable.

### BACKGROUND OF THE INVENTION

The present invention relates to the field of visual indicators. Specifically, the present invention relates to the ability to allow a person or persons the ability to visually determine the current acceleration of an object along a specified axis within an inertial frame of reference.

For clarity acceleration includes both positive and negative accelerations, where negative acceleration is commonly referred to as deceleration. The object could be anything that undergoes acceleration relative to the frame of reference. An example could be a vehicle that is accelerating on a road.

No prior art is known to the Applicant.

### BRIEF SUMMARY OF THE INVENTION

An acceleration system hardware for calculating and displaying acceleration information relevant to the movement of vehicle. Said acceleration system hardware comprises a plurality of computation components and a display system. Said plurality of computation components comprises a sensor package, a memory and a processing unit. Said sensor package comprises at least an accelerometer. Said memory comprises a system application which is in communication with said plurality of computation components and executed in said processing unit. Said display system is configured for converting processed accelerometer data into a visual indication of the magnitude of the acceleration. Said acceleration system hardware is configured for capturing acceleration data with said accelerometer. processing said acceleration data with said processing unit into said processed accelerometer data. ingesting said processed accelerometer data with said processing unit according to said system application. interpreting said processed accelerometer data along forward movement axis in a 3-dimensional space. sending said processed accelerometer data to the display unit for visual indication of said processed accelerometer data. Said processing unit is configured for determining acceleration in any of the 3 axis in 3-dimensional space, and determining net acceleration along any particular axis. Said system application comprises a main program, a display driver, one or more acceleration algorithms, and a hardware interface algorithms. Said main program comprises a configuration data which is written to said accelerometer in order to specify data refresh rates, data formats, and other device specific configurations. Said accelerometer is configured to collect said acceleration data. Said processing unit is configured to execute said system application to transform said acceleration data into said processed accelerometer data. Said system application is further configured for sending a display signals to a visual indicator on said vehicle for visual display of said processed accelerometer data. Said visual indicator comprises a plurality of multicolored LEDs. Said plurality of multicolored LEDs comprises of 7 red light emitting diodes and 7 green light emitting diodes. Said plurality of multicolored LEDs is controlled by transistors which are connected via the general purpose input/output interface of said processing unit, such as a Raspberry Pi.

Said acceleration system hardware for calculating and displaying acceleration information relevant to the movement of said vehicle. Said acceleration system hardware comprises said plurality of computation components and said display system. Said plurality of computation components comprises said sensor package, said memory and said processing unit. Said sensor package comprises at least said accelerometer. Said memory comprises said system application which is in communication with said plurality of computation components and executed in said processing unit. Said display system is configured for converting said processed accelerometer data into a visual indication of the magnitude of the acceleration. Said acceleration system hardware is configured for capturing said acceleration data with said accelerometer. processing said acceleration data with said processing unit into said processed accelerometer data. ingesting said processed accelerometer data with said processing unit according to said system application. interpreting said processed accelerometer data along said forward movement axis in a 3-dimensional space. sending said processed accelerometer data to the display unit for visual indication of said processed accelerometer data.

### BRIEF DESCRIPTION OF THE SEVERAL VIEWS OF THE DRAWING

FIG. 1 illustrates a block diagram of an acceleration system hardware 100.

FIG. 2 illustrates a flow diagram describing a method of use 200 for said acceleration system hardware 100.

FIG. 3 illustrates a software block diagram of a system application 116.

FIG. 4 illustrates an elevated side view and top view of vehicle 400 comprising said acceleration system hardware 100 and a display system 120.

FIGS. 5A, 5B, 5C, and 5D illustrate an elevated side view of said vehicle 400 on a slope 500, and a vector magnitude diagram 502.

### DETAILED DESCRIPTION OF THE INVENTION

The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

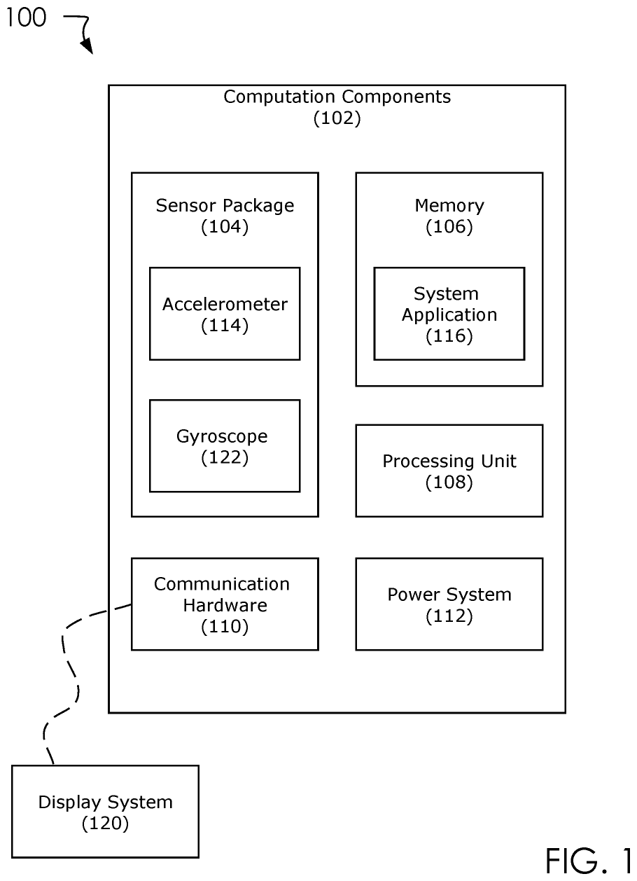

FIG. 1 illustrates a block diagram of an acceleration system hardware 100.

In one embodiment, said acceleration system hardware 100 can interact so as to display acceleration information, as discussed herein. Said acceleration system hardware 100 can comprise a plurality of computation components 102 which can comprise a sensor package 104, a memory 106, a processing unit 108, a communication hardware 110, and a power system 112. In one embodiment, said sensor package 104 can comprise an accelerometer 114, and said memory 106 can store and access a system application 116. In one embodiment, said plurality of computation components 102 can communicate with a display system 120, such as a string of LEDs, vehicle lights, or standard computer screen.

In one embodiment, 104/can further comprise a gyroscope 122.

In one embodiment, said accelerometer 114 can comprise an Adafruit 3-Axis 14-bit Accelerometer capable of measuring acceleration in ranges of +/−2, +/−4, and +/−8 g, where g is the acceleration due to gravity. Said processing unit 108 can comprise a Raspberry Pi 4 computer, said accelerometer 114 is connected to the Raspberry Pi via a I2C bus. In one embodiment, the code for said system application 116, which can be required to control and read said accelerometer 114, can be embedded in said processing unit 108 and is written in the C programming language.

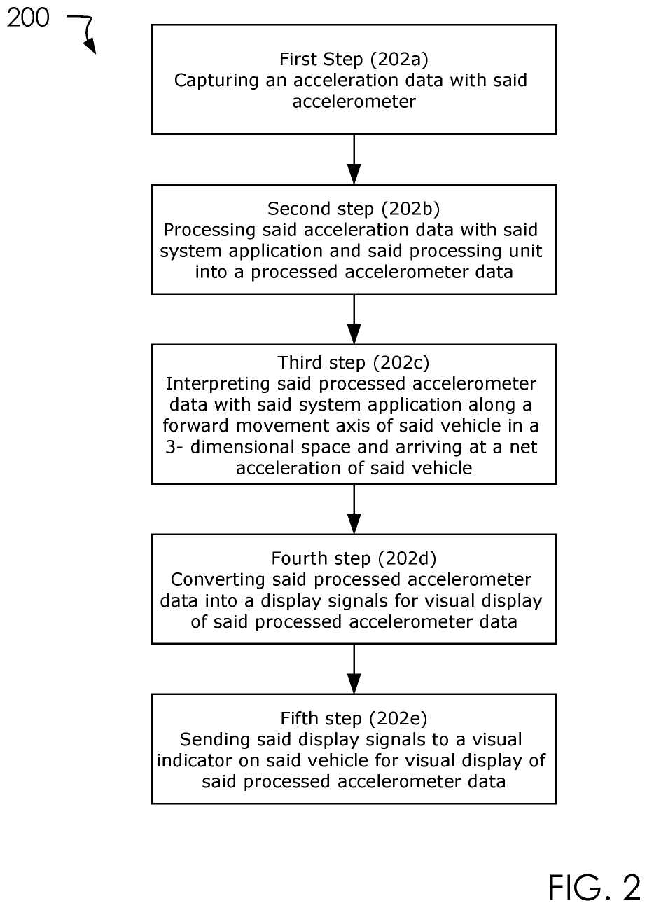

FIG. 2 illustrates a flow diagram describing a method of use 200 for said acceleration system hardware 100.

Said method of use 200 can comprise a plurality of steps 202 (which can comprise a first step 202a, a second step 202b, a third step 202c, a fourth step 202d and a fifth step 202e).

In one embodiment, said first step 202a can comprise capturing acceleration data 204 with said accelerometer 114; said second step 202b can comprise processing said acceleration data 204 with said system application 116 and said processing unit 108 into processed accelerometer data 206; said third step 202c can comprise interpreting said processed accelerometer data 206 with said system application 116 along forward movement axis 406 of vehicle 400 in a 3-dimensional space and arriving at net acceleration 208 of said vehicle 400; said fourth step 202d can comprise converting said processed accelerometer data 206 into a display signals 408 for visual display of said processed accelerometer data 206; and said fifth step 202e can comprise sending said display signals 408 to a visual indicator 410 on said vehicle 400 for visual display of said processed accelerometer data 206.

In one embodiment, said processing unit 108 can be configured for determining acceleration in any of the 3 axis in 3-dimensional space. Said processing unit 108 can also be capable of determine said net acceleration 208 along any particular axis, such as the direction a vehicle is heading. In determining said net acceleration 208 of the object, the acceleration due to gravity is compensated in said processing unit 108.

In one embodiment, the centripetal acceleration strictly due to movement around a radius is not desired to be in the final display and can be removed in said processing unit 108. Said processing unit 108 can then send said processed accelerometer data 206 to the display unit for visual indication of the processed acceleration.

In one embodiment, said processed accelerometer data 206 can comprise be any format agreed upon between said accelerometer 114 and said processing unit 108, and can be an industry standard data transfer method. Said accelerometer 114 can send said processed accelerometer data 206 at any data rate that is agreed upon by said accelerometer 114 and said processing unit 108.

Said display system 120 can comprise the ability to convert said processed accelerometer data 206 into a visual indication of the magnitude of the acceleration. In one embodiment, said display system 120 can comprise a number of Light Emitting Diodes (“LED's”) configure to turned on and off; wherein, the greater number of lights turned on indicating the magnitude of the acceleration and the color of the lights indicating if the acceleration is positive or negative (deceleration).

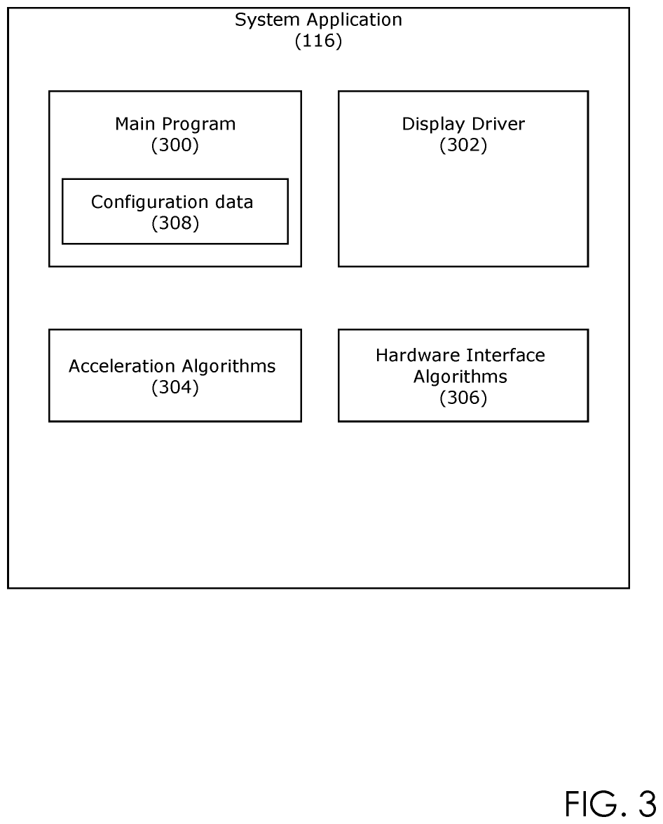

FIG. 3 illustrates a software block diagram of said system application 116.

In one embodiment, said system application 116 can comprise a main program 300, a display driver 302, one or more acceleration algorithms 304, and a hardware interface algorithms 306.

In one embodiment, said main program 300 can comprise a configuration data 308 which can be written to said accelerometer 114 in order to specify data refresh rates, data formats, and other device specific configurations. Wherein, said accelerometer 114 can comprise an industry standard accelerometer that can communicate via electrical signals to a microcomputer processing unit.

In one embodiment, said accelerometer 114 sends said acceleration data 204 for each axis in a 3-dimensional space.

In one embodiment, all among said acceleration data 204 can be sent to said processing unit 108 for processing for visual display and subsequently sent to said display system 120. In one embodiment, said display system 120 can comprise any device that can visually represent the magnitude of the data sent from said processing unit 108, as is known in the art.

In one embodiment, said system application 116 can comprise a control logic executed in said processing unit 108 which can comprise an accelerometer interface, illustrated here as said hardware interface algorithms 306. In one embodiment, said hardware interface algorithms 306 can comprise an I2C industry standard interface, an algorithm to reduce the data obtained from said accelerometer 114 to a magnitude to be displayed, and the display driver than converts the magnitude to data that the display can visually represent.

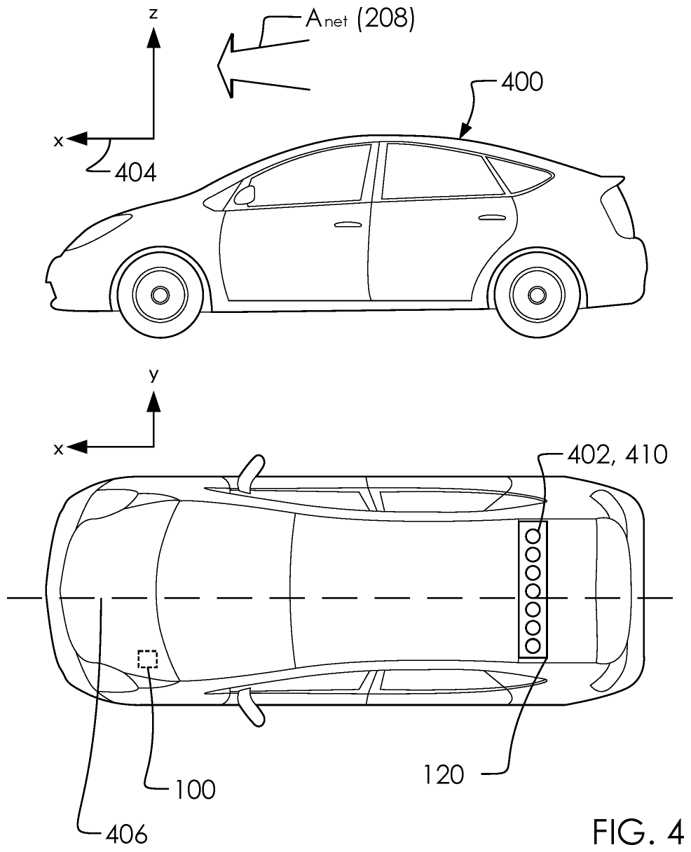

FIG. 4 illustrates an elevated side view and top view of said vehicle 400 comprising said acceleration system hardware 100 and said display system 120.

In one embodiment, said display system 120 can comprise a display unit comprising a custom built display which can comprise a plurality of multicolored LEDs 402. In one embodiment, said plurality of multicolored LEDs 402 can comprise of 7 red light emitting diodes and 7 green light emitting diodes. Said plurality of multicolored LEDs 402 can be controlled by transistors which are connected via the general purpose input/output interface of said processing unit 108, such as a Raspberry Pi.

In one embodiment, said accelerometer 114 can map a direction of vehicle travel 404 as the positive x-axis and the negative z-axis as downward in the direction of the pull of gravity.

In one embodiment, said one or more acceleration algorithms 304 can comprise at least an algorithm for calculating acceleration utilizing the square root of the squares of the acceleration in the main direction of travel, namely said direction of vehicle travel 404.

In one embodiment, the acceleration due to Earth's gravity can be subtracted from this result to obtain the acceleration only in the direction of travel of the object on a plane parallel to the Earth's surface at that current locality of the object. In this embodiment, the third axis (the y axis) can be ignored. Wherein, ignoring the third axis prevents incorrect acceleration magnitude from being represented due to centripetal forces acting on an object moving in an arc.

In this embodiment, said accelerometer 114 can be mounted in a manner that allows is to be stationary relative to the frame of said vehicle 400.

In one embodiment, the three axis of acceleration to be measured would be said direction of vehicle travel 404 of said vehicle 400; wherein, said direction of vehicle travel 404 can be pointing directly towards the front of said vehicle 400, and an axis pointing directly down from said vehicle 400, and a third axis perpendicular to the first two that points towards the side of said vehicle 400.

Said accelerometer 114 may be in a separate location from said processing unit 108, but is not required to be so. Said processing unit 108 can be located somewhere on said vehicle 400 that allows it to operate successfully and securely. Said display system 120 and/or said plurality of multicolored LEDs 402 in this embodiment can be located near the rear of said vehicle 400.

In one embodiment, said plurality of multicolored LEDs 402 can be configured to be easily visible from another vehicle that may be behind said vehicle 400. In one embodiment, said plurality of multicolored LEDs 402 can be in data communication with said processing unit 108 via signals that allow the transmission of the data necessary to display the magnitude of acceleration/deceleration upon the display.

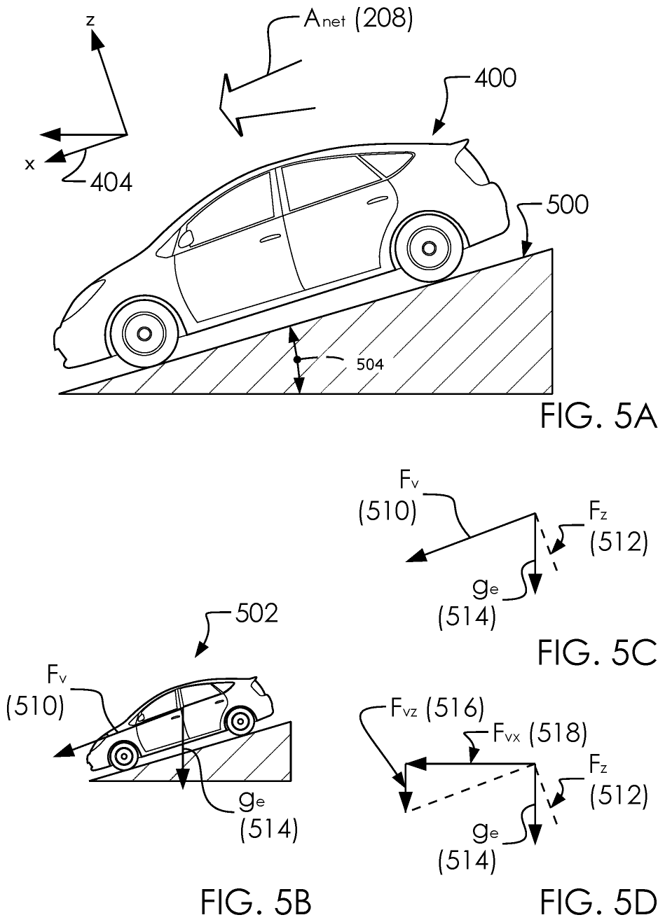

FIGS. 5A, 5B, 5C, and 5D illustrate an elevated side view of said vehicle 400 on a slope 500, and a vector magnitude diagram 502.

In one embodiment, said vehicle 400 can be on said slope 500 having an inclined angle 504 (comprising an angle measured as above horizontal).

As is known in the art, when an object is on said slope 500, the forces relative to said vehicle 400 will change due to the relative change in the vector of gravity. Thus, said net acceleration 208 can be altered when said vehicle 400 is on said slope 500.

Shown in FIG. 5A, said vehicle 400 is on said slope 500, having said inclined angle 504.

As shown in FIGS. 5B-5D, with said vehicle 400 on said slope 500, said slope 500 can comprise a force of vehicle acceleration 510 moving in said direction of vehicle travel 404 or in the x-axis, and not on a horizontal plane. Further wherein, a z-axis force 512 is no longer substantially equal with a gravitational force 514.

In one embodiment, said gyroscope 122 can be capable of determining gyroscope capable of determining said inclined angle 504.

Said force of vehicle acceleration 510 can be broken into vectors comprising a vehicle z-axis force 516 and a vehicle x-axis force 518, as illustrated. Wherein, said accelerometer 114 may be configured for calculating said z-axis force 512, comparing said z-axis force 512 with said gravitational force 514, determining if said gravitational force 514 is dissimilar to said z-axis force 512 for a given period of time, and thereby determining the relative vector magnitudes of said force of vehicle acceleration 510, said vehicle z-axis force 516 and said vehicle x-axis force 518.

In one embodiment, said net acceleration 208 can be calculated as a sum of said force of vehicle acceleration 510 and a portion of said gravitational force 514, as is known in the art.

The following listing of the parts in the figures is included for the convenience of the reader:
said acceleration system hardware 100,
said plurality of computation components 102,
said sensor package 104,
said memory 106,
said processing unit 108,
said communication hardware 110,
said power system 112,
said accelerometer 114,
said system application 116,
said display system 120,
said method of use 200,
said plurality of steps 202,
said first step 202a,
said second step 202b,
said third step 202c,
said fourth step 202d,
said acceleration data 204,
said processed accelerometer data 206,
said net acceleration 208,
said main program 300,
said display driver 302,
said one or more acceleration algorithms 304,
said hardware interface algorithms 306,
said configuration data 308,
said vehicle 400,
said plurality of multicolored LEDs 402 and
said direction of vehicle travel 404.

These sentences are added with reference to the claims:

Said acceleration system hardware 100 for calculating and displaying acceleration information relevant to the movement of said vehicle 400. Said acceleration system hardware 100 comprises said plurality of computation components 102 and said display system 120. Said plurality of computation components 102 comprises said sensor package 104, said memory 106 and said processing unit 108. Said sensor package 104 comprises at least said accelerometer 114. Said memory 106 comprises said system application 116 which can be in communication with said plurality of computation components 102 and executed in said processing unit 108. Said acceleration system hardware 100 can be configured for capturing said acceleration data 204 with said accelerometer 114, processing said acceleration data 204 with said system application 116 and said processing unit 108 into said processed accelerometer data 206, interpreting said processed accelerometer data 206 with said system application 116 along said forward movement axis 406 of said vehicle 400 in a 3-dimensional space and arriving at said net acceleration 208 of said vehicle 400, converting said processed accelerometer data 206 into said display signals 408 for visual display of said processed accelerometer data 206, and sending said display signals 408 to said visual indicator 410 on said vehicle 400 for visual display of said processed accelerometer data 206. Said visual indicator 410 of said display system 120 comprises said plurality of multicolored LEDs 402 configure to turned on and off according to said display signals 408. Said system application 116 can be configured for adjusting said display signals 408 based on said net acceleration 208, increasing or deceasing within said display signals 408 a number of said plurality of multicolored LEDs 402 to turn on as an indication of a magnitude of said net acceleration 208 where an increased number indicates a positive said net acceleration 208 and a decreased number indicates a negative said net acceleration 208, and altering a signal within said display signals 408 as between a first color associated with a positive said net acceleration 208 and a second color associated with a negative said net acceleration 208 in said net acceleration 208. Said system application 116 comprises said main program 300, said display driver 302, said one or more acceleration algorithms 304, and said hardware interface algorithms 306.

Said acceleration system hardware 100 for calculating and displaying acceleration information relevant to the movement of said vehicle 400. Said acceleration system hardware 100 comprises said plurality of computation components 102 and said display system 120. Said plurality of computation components 102 comprises said sensor package 104, said memory 106 and said processing unit 108. Said sensor package 104 comprises at least said accelerometer 114. Said memory 106 comprises said system application 116 which can be in communication with said plurality of computation components 102 and executed in said processing unit 108. Said acceleration system hardware 100 can be configured for capturing said acceleration data 204 with said accelerometer 114, processing said acceleration data 204 with said system application 116 and said processing unit 108 into said processed accelerometer data 206, interpreting said processed accelerometer data 206 with said system application 116 along said forward movement axis 406 of said vehicle 400 in a 3-dimensional space and arriving at said net acceleration 208 of said vehicle 400, converting said processed accelerometer data 206 into said display signals 408 for visual display of said processed accelerometer data 206, and sending said display signals 408 to said visual indicator 410 on said vehicle 400 for visual display of said processed accelerometer data 206.

Said accelerometer 114 comprises an Adafruit 3-Axis 14-bit Accelerometer capable of measuring acceleration in ranges of +/−2, +/−4, and +/−8 g, where g can be the acceleration due to gravity. Said processing unit 108 comprises a Raspberry Pi 4 computer, said accelerometer 114 can be connected to the Raspberry Pi via a I2C bus. the code for said system application 116, which can be required to control and read said accelerometer 114, can be embedded in said processing unit 108 and can be written in the C programming language.

Said processing unit 108 executing said system application 116 can be configured for determining acceleration in any of the 3 axis in 3-dimensional space, and determining said net acceleration 208 along any particular axis. the centripetal acceleration strictly due to movement around a radius can be not desired to be in said display system 120 and can be removed in said processing unit 108.

Said processed accelerometer data 206 comprises be any format agreed upon between said accelerometer 114 and said processing unit 108, and can be an industry standard data transfer method. Said accelerometer 114 can be configured to send said acceleration data 204 at any data rate that can be agreed upon by said accelerometer 114 and said processing unit 108.

Said visual indicator 410 of said display system 120 comprises said plurality of multicolored LEDs 402 configure to turned on and off according to said display signals 408. Said system application 116 can be configured for adjusting said display signals 408 based on said net acceleration 208, increasing or deceasing within said display signals 408 a number of said plurality of multicolored LEDs 402 to turn on as an indication of a magnitude of said net acceleration 208 where an increased number indicates a positive said net acceleration 208 and a decreased number indicates a negative said net acceleration 208, and altering a signal within said display signals 408 as between a first color associated with a positive said net acceleration 208 and a second color associated with a negative said net acceleration 208 in said net acceleration 208.

Said plurality of multicolored LEDs 402 comprises of 7 red light emitting diodes and 7 green light emitting diodes. Said plurality of multicolored LEDs 402 can be controlled by transistors which can be connected via the general purpose input/output interface of said processing unit 108, such as a Raspberry Pi.

Said visual indicator 410 of said display system 120 comprises said plurality of multicolored LEDs 402 configure to turned on and off according to said display signals 408. Said system application 116 can be configured for adjusting said display signals 408 based on said net acceleration 208, and increasing or deceasing within said display signals 408 a number of said plurality of multicolored LEDs 402 to turn on as an indication of a magnitude of said net acceleration 208 where an increased number indicates a positive said net acceleration 208 and a decreased number indicates a negative said net acceleration 208.

Said visual indicator 410 of said display system 120 comprises said plurality of multicolored LEDs 402 configure to turned on and off according to said display signals 408. Said system application 116 can be configured for adjusting said display signals 408 based on said net acceleration 208, and altering a signal within said display signals 408 as between a first color associated with a positive said net acceleration 208 and a second color associated with a negative said net acceleration 208 in said net acceleration 208.

Said system application 116 comprises said main program 300, said display driver 302, said one or more acceleration algorithms 304, and said hardware interface algorithms 306.

Said main program 300 comprises said configuration data 308 which can be written to said accelerometer 114 in order to specify data refresh rates, data formats, and other device specific configurations.

Said visual indicator 410 comprises any device that can be configured to visually represent said net acceleration 208.

Said system application 116 comprises a control logic executed in said processing unit 108 which comprises said hardware interface algorithms 306. Said hardware interface algorithms 306 can be configured to communicate between two or more among said plurality of computation components 102.

Said hardware interface algorithms 306 comprises an I2C industry standard interface, an algorithm to reduce the data obtained from said accelerometer 114 to a magnitude to be displayed, and the display driver than converts the magnitude to data that the display can be configured to visually represent.

Said accelerometer 114 can be configured to map said direction of vehicle travel 404 as the positive x-axis and the negative z-axis as downward in the direction of the pull of gravity. Said one or more acceleration algorithms 304 comprises at least an algorithm for calculating acceleration utilizing the square root of the squares of the acceleration in the main direction of travel, namely said direction of vehicle travel 404.

Said accelerometer 114 can be in a separate location on said vehicle 400 from said processing unit 108. Said processing unit 108 can be located somewhere on said vehicle 400 that allows it to operate successfully and securely. Said visual indicator 410 can be located near the rear of said vehicle 400.

Said method of use 200 of said acceleration system hardware 100 for calculating and displaying acceleration information relevant to the movement of said vehicle 400. Said method of use 200 comprises capturing said acceleration data 204 with said accelerometer 114, processing said acceleration data 204 with said system application 116 and said processing unit 108 into said processed accelerometer data 206, interpreting said processed accelerometer data 206 with said system application 116 along said forward movement axis 406 of said vehicle 400 in a 3-dimensional space and arriving at said net acceleration 208 of said vehicle 400, converting said processed accelerometer data 206 into said display signals 408 for visual display of said processed accelerometer data 206, and sending said display signals 408 to said visual indicator 410 on said vehicle 400 for visual display of said processed accelerometer data 206. Said acceleration system hardware 100 comprises said plurality of computation components 102 and said display system 120. Said plurality of computation components 102 comprises said sensor package 104, said memory 106 and said processing unit 108. Said sensor package 104 comprises at least said accelerometer 114. Said memory 106 comprises said system application 116 which can be in communication with said plurality of computation components 102 and executed in said processing unit 108. Said display system 120 can be configured for converting said processed accelerometer data 206 into a visual indication of the magnitude of the acceleration.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. An acceleration system hardware for calculating and displaying acceleration information relevant to the movement of vehicle, wherein:
said acceleration system hardware comprises a plurality of computation components and a display system;
said plurality of computation components comprises a sensor package, a memory and a processing unit;
said sensor package comprises at least an accelerometer;
said memory comprises a system application which is in communication with said plurality of computation components and executed in said processing unit;
said acceleration system hardware is configured for
capturing acceleration data with said accelerometer,
processing said acceleration data with said system application and said processing unit into processed accelerometer data,
interpreting said processed accelerometer data with said system application along forward movement axis of said vehicle in a 3-dimensional space and arriving at net acceleration of said vehicle,
converting said processed accelerometer data into a display signals for visual display of said processed accelerometer data, and
sending said display signals to a visual indicator on said vehicle for visual display of said processed accelerometer data;
said visual indicator of said display system comprises a plurality of multicolored LEDs configure to turned on and off according to said display signals;
said system application is configured for
adjusting said display signals based on said net acceleration,
increasing or deceasing within said display signals a number of said plurality of multicolored LEDs to turn on as an indication of a magnitude of said net acceleration where an increased number indicates a positive said net acceleration and a decreased number indicates a negative said net acceleration, and
altering a signal within said display signals as between a first color associated with a positive said net acceleration and a second color associated with a negative said net acceleration in said net acceleration; and
said system application comprises a main program, a display driver, one or more acceleration algorithms, and a hardware interface algorithms.

2. An acceleration system hardware for calculating and displaying acceleration information relevant to the movement of vehicle, wherein:
said acceleration system hardware comprises a plurality of computation components and a display system;
said plurality of computation components comprises a sensor package, a memory and a processing unit;
said sensor package comprises at least an accelerometer;
said memory comprises a system application which is in communication with said plurality of computation components and executed in said processing unit;
said acceleration system hardware is configured for
capturing acceleration data with said accelerometer,
processing said acceleration data with said system application and said processing unit into processed accelerometer data,
interpreting said processed accelerometer data with said system application along forward movement axis of said vehicle in a 3-dimensional space and arriving at net acceleration of said vehicle,
converting said processed accelerometer data into a display signals for visual display of said processed accelerometer data, and
sending said display signals to a visual indicator on said vehicle for visual display of said processed accelerometer data.

3. The acceleration system hardware of claim 2, wherein:
said accelerometer comprises an Adafruit 3-Axis 14-bit Accelerometer capable of measuring acceleration in ranges of +/−2, +/−4, and +/−8 g, where g is the acceleration due to gravity;
said processing unit comprises a Raspberry Pi 4 computer, said accelerometer is connected to the Raspberry Pi via a I2C bus; and
the code for said system application, which is required to control and read said accelerometer, is embedded in said processing unit and is written in the C programming language.

4. The acceleration system hardware of claim 2, wherein:
said processing unit executing said system application is configured for
determining acceleration in any of the 3 axis in 3-dimensional space, and
determining said net acceleration along any particular axis; and
the centripetal acceleration strictly due to movement around a radius is not desired to be in said display system and is removed in said processing unit.

5. The acceleration system hardware of claim 2, wherein:
said processed accelerometer data comprises be any format agreed upon between said accelerometer and said processing unit, and is an industry standard data transfer method; and
said accelerometer is configured to send said acceleration data at any data rate that is agreed upon by said accelerometer and said processing unit.

6. The acceleration system hardware of claim 2, wherein:
said visual indicator of said display system comprises a plurality of multicolored LEDs configure to turned on and off according to said display signals;
said system application is configured for
adjusting said display signals based on said net acceleration,
increasing or deceasing within said display signals a number of said plurality of multicolored LEDs to turn on as an indication of a magnitude of said net acceleration where an increased number indicates a positive said net acceleration and a decreased number indicates a negative said net acceleration, and
altering a signal within said display signals as between a first color associated with a positive said net acceleration and a second color associated with a negative said net acceleration in said net acceleration.

7. The acceleration system hardware of claim 6, wherein:
said plurality of multicolored LEDs comprises of 7 red light emitting diodes and 7 green light emitting diodes; and
said plurality of multicolored LEDs is controlled by transistors which are connected via the general purpose input/output interface of said processing unit, such as a Raspberry Pi.

8. The acceleration system hardware of claim 2, wherein:
said visual indicator of said display system comprises said plurality of multicolored LEDs configure to turned on and off according to said display signals;
said system application is configured for
adjusting said display signals based on said net acceleration, and
increasing or deceasing within said display signals a number of said plurality of multicolored LEDs to turn on as an indication of a magnitude of said net acceleration where an increased number indicates a positive said net acceleration and a decreased number indicates a negative said net acceleration.

9. The acceleration system hardware of claim 2, wherein:
said visual indicator of said display system comprises said plurality of multicolored LEDs configure to turned on and off according to said display signals;
said system application is configured for
adjusting said display signals based on said net acceleration, and
altering a signal within said display signals as between a first color associated with a positive said net acceleration and a second color associated with a negative said net acceleration in said net acceleration.

10. The acceleration system hardware of claim 2, wherein:
said system application comprises a main program, a display driver, one or more acceleration algorithms, and a hardware interface algorithms.

11. The acceleration system hardware of claim 10, wherein:
said main program comprises a configuration data which is written to said accelerometer in order to specify data refresh rates, data formats, and other device specific configurations.

12. The acceleration system hardware of claim 2, wherein:
said visual indicator comprises any device that is configured to visually represent said net acceleration.

13. The acceleration system hardware of claim 2, wherein:
said system application comprises a control logic executed in said processing unit which comprises said hardware interface algorithms; and
said hardware interface algorithms are configured to communicate between two or more among said plurality of computation components.

14. The acceleration system hardware of claim 13, wherein:
said hardware interface algorithms comprises an I2C industry standard interface, an algorithm to reduce the data obtained from said accelerometer to a magnitude to be displayed, and the display driver than converts the magnitude to data that the display is configured to visually represent.

15. The acceleration system hardware of claim 2, wherein:
said accelerometer is configured to map a direction of vehicle travel as the positive x-axis and the negative z-axis as downward in the direction of the pull of gravity; and
said one or more acceleration algorithms comprises at least an algorithm for calculating acceleration utilizing the square root of the squares of the acceleration in the main direction of travel, namely said direction of vehicle travel.

16. The acceleration system hardware of claim 2, wherein:
said accelerometer is in a separate location on said vehicle from said processing unit;
said processing unit is located somewhere on said vehicle that allows it to operate successfully and securely; and
said visual indicator is located near the rear of said vehicle.

17. A method of use of an acceleration system hardware for calculating and displaying acceleration information relevant to the movement of vehicle, wherein:
said method of use comprises
capturing acceleration data with an accelerometer,
processing said acceleration data with a system application and a processing unit into processed accelerometer data,
interpreting said processed accelerometer data with said system application along forward movement axis of said vehicle in a 3-dimensional space and arriving at net acceleration of said vehicle,
converting said processed accelerometer data into a display signals for visual display of said processed accelerometer data, and
sending said display signals to a visual indicator on said vehicle for visual display of said processed accelerometer data; wherein,
said acceleration system hardware comprises a plurality of computation components and a display system;
said plurality of computation components comprises a sensor package, a memory and said processing unit;
said sensor package comprises at least said accelerometer;
said memory comprises said system application which is in communication with said plurality of computation components and executed in said processing unit; and
said display system is configured for converting said processed accelerometer data into a visual indication of the magnitude of the acceleration.
